(19) United States
(12) Patent Application Publication
(10) Pub. No.: US 2007/0038763 A1
(43) Pub. Date: Feb. 15, 2007

(54) Method of enabling a multitasking computing device to conserve resources

(75) Inventor: Magnus Evert Oestvall, Karlskrona (SE)

Correspondence Address: SYNNESTVEDT LECHNER & WOODBRIDGE LLP, P O BOX 592, 112 NASSAU STREET, PRINCETON, NJ, 08542-0592, US

(73) Assignee: Symbian Software Limited, London (GB)

(21) Appl. No.: 10/562,326

(22) PCT Filed: Jul. 2, 2004
(86) PCT No.: PCT/GB04/02912

§ 371 Date: May 30, 2006

(30) Foreign Application Priority Data
Jul. 2, 2003 (GB) 0315492.9

(51) Int. Cl. G06F 15/16

(52) U.S. Cl. 709/229

(57) ABSTRACT

A multitasking battery operated computing device preserves battery power by determining if an untrusted application is in the background or foreground and preventing an untrusted application that is in the background from running. A window server component may be used to determine if an untrusted application is in the background or foreground; for applications in the background, it can send a control signal to the scheduler or interrupt handler that in effect prevents the untrusted application from running, e.g. being given any services or consuming any resources.

### BACKGROUND OF THE INVENTION

1. Field of the Invention

This invention relates to a method of enabling a multitasking computing device to preserve or conserve resources, such as battery power. The term ‘computing device’ used in this patent specification should be expansively construed to cover any kind of computing device and includes without limitation radio telephones, smart phones, communicators, personal computers, lap top computers, game consoles, computers and application specific devices.

2. Description of the Prior Art

Battery conservation in battery operated computing devices is very important, particularly in devices such as smartphones that consume high power levels by virtue of connecting to always-on GPRS or 3G cellular networks.

In conventional multi-tasking computers running several different applications at the same time, an application will issue a software interrupt to the operating system when it first requests services; interrupts from different applications are prioritised and queued by an interrupt handler. A scheduler starts and ends applications and manages concurrently running applications.

Conventionally, the scheduler will end an application when instructed to do so by the end user, e.g. selecting a ‘close’ option in the application's drop down menu. Consequently, without an explicit ‘close’ command, applications will continue to run even when not actually in active use; they will therefore continue to use some system resources, even when residing in the ‘background’. An application is in the background if it is not being interacted with by an end-user and it presents no user interface with which a user could interact (but it could for example present an icon indicating its presence and the fact that it was still active). A foreground application conversely does present a user interface with which a user can interact.

Hence, the problem of battery conservation is especially acute for multi-tasking devices, i.e. devices with an operating system that can run several applications at the same time.

### SUMMARY OF THE INVENTION

In a first aspect of the present invention, a multitasking computing device determines if a non-trusted application is in the background or foreground and prevents an untrusted application that is in the background from running in order to preserve system resources.

It is valuable to preserve system resources (CPU, power) in multitasking computing devices: For mains powered desktop computers, the fact that applications can run in the background and hence still consume some system resource is a waste of CPU and scheduler activity. And in the battery operated, portable device domain, it is especially valuable to conserve system resources wherever possible since doing so can increase battery life, as noted earlier.

A device implementing the present invention preserves system resources by denying system resources and services to background applications that do not meet predefined ‘trust’ or certification criteria—i.e. criteria which define the level of trustworthiness of the application. There are various criteria that may be relevant in assessing whether a give application is ‘untrusted’ or not; these include, without limitation:
(a) which protected resources on the device can be accessed by the application: an ‘untrusted’ application might be defined as one that is not able to access certain predefined protected resources; or
(b) whether the application was loaded from ROM or RAM: applications loaded from RAM are likely to be from third party sources and hence less trustworthy than applications loaded from ROM, which would typically be provided by the device manufacturer; or
(c) whether the application has been validated using some predefined validation or certification process.

Applications might, in theory, be written so that they take notice of an event sent to them when they are sent to background, causing them to automatically cease running. But even this is likely to be missed in applications which are from certain kinds of third party programmers or are not validated as proper implementations—i.e. ‘untrusted’ applications. ‘Untrusted’ applications are therefore more likely to contain a wrong implementation of normal background behaviour: hence, merely relying on an application to voluntarily cease running when notified that it is in the background is an inadequate strategy for untrusted applications. Instead, they need to be actively prevented from running.

With the present invention, untrusted third party applications (such as downloaded applications like games) are prevented from running in the background and are suspended. Trusted applications may still be allowed to run in the background, or they may be actively prevented in the same way as non-trusted applications, or they may be requested (but not prevented) to stop running if in background. Trust will conventionally be established for a given application using a signature in the application installation file, although there are other techniques that may be deployed as part of the secure computing base of the device.

In a second aspect, there is a multitasking computing device programmed to be capable of determining if an untrusted application is in the background or foreground and preventing an untrusted application that is in the background from running in order to conserve system resources. The device may be battery powered.

In a third aspect, there is an operating system for a multitasking computing device, the operating system being capable of determining if an untrusted application is in the background or foreground and preventing an untrusted application that is in the background from running in order to conserve system resources.

### BRIEF DESCRIPTION OF THE DRAWING

The invention will be described with reference to the accompanying drawing, which is a schematic of some of the components of a device in accordance with the present invention.

### DETAILED DESCRIPTION

The present invention can be implemented on battery operated devices running SymbianOS operating system. SymbianOS based phones are ‘open’ for third party applications. The third party applications are often games or similar types of applications and, when these execute, the CPU is often running at full speed to update graphics, sounds etc. When the user or the system needs to display another application or dialog, there is a risk that the third party application will still run in the background and thus drain the battery.

Third party applications can either come from ‘trusted’ sources or ‘untrusted’ sources. This may be determined by a signature in the installation file. An alternative approach to platform security on SymbianOS is described in PCT/GB2003/002311, the contents of which are incorporated by reference.

With the present invention, when an untrusted application is running on the battery operated device and another application should be in the foreground, the untrusted application is placed into the background and is also actively prevented from running. This denies it system resources and hence preserves power, as well as unnecessary CPU activity associated with the untrusted application in background. Preserving system resources could be especially valuable not only in the context of portable, battery powered devices, but also a UPS (uninterruptible power supply) powered system: once activated because a primary power source has ceased to provide power, the need to preserve system resources for as long as possible is very valuable. When the untrusted application is brought to the foreground again, it is allowed to run again.

The scheme is implemented by a system component which both knows which processes and threads belong to trusted or untrusted applications as well as knows which application is in foreground and which ones are in background. In Symbian OS, this is most likely to be the window server component. C++ andJava applications can also be controlled in this way.

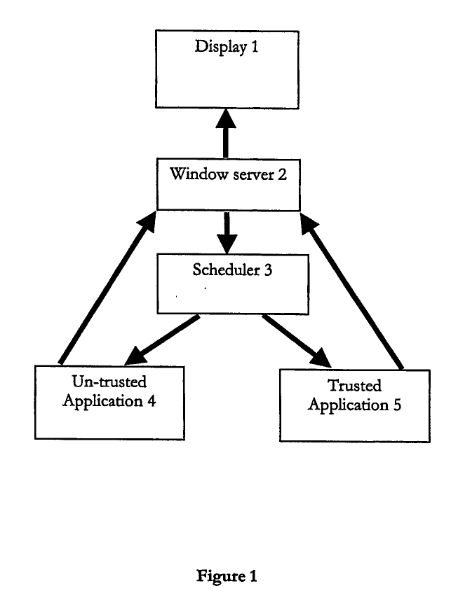

Referring now to FIG. 1, a window server component 2 is used to determine if an application is in the background or foreground on display 1; for an untrusted application 4 in the background, it can send a control signal to the scheduler 3 or interrupt handler that in effect prevents the untrusted application 4 from running, e.g. being given any services or consuming any resources. The scheduler could for example, simply operate so as to never allocate any services or resources to the background untrusted application 4; an alternative would be for the interrupt handler to simply place any interrupts from the background untrusted application 4 to the back of its queue and never allow them to be executed. When in the background, trusted application 5 may continue to run, or may be actively prevented in the same way as non-trusted application 4, or may be requested (but not prevented) to stop running.

One example use of the present invention is to prevent background untrusted applications from ‘polling’ for data over a wireless network, an activity that can potentially drain a battery quickly. Another example is that untrusted applications will automatically be prevented from running if the display shows a screen saver or is actually turned off (battery operated devices can perform useful functions such as telephony even when the screen is turned oft). Hence, the present invention is a valuable addition to power conservation strategies, especially (although without limitation) to battery operated devices.

When the device determines that an application is in the foreground (again, as may be determined by a window server component), it allows that application to run again—e.g. to be provided with resources and services.

1. A method of enabling a multitasking computing device to preserve system resources, comprising the steps of determining if an untrusted application is in the background or foreground and preventing an untrusted application that is in the background from running.

2. The method of claim 1 in which a window server component determines if the untrusted application is in the background or foreground.

3. The method of claim 2 in which, for an untrusted application in the background, the window server sends a control signal to a scheduler or interrupt handler to prevent the application from running.

4. The method of claim 1 comprising the further step of preventing an untrusted background application from ‘polling’ for data over a wireless network.

5. The method of claim 1 comprising the further step of preventing an untrusted background application from running if a display shows a screen saver or is turned off.

6. The method of claim 1 in which a trusted application in the background is (i) still allowed to run, or (ii) actively prevented from running or (III) requested to stop running.

7. The method of claim 1 in which an application has been deemed to be untrusted by the device assessing:
(a) which protected resources on the device can be accessed by the application; or
(b) whether the application was loaded from ROM or RAM; or
(c) whether the application has been validated using some predefined validation or certification process.

8. The method of claim 7 in which a background application is prevented from running only if it does not meet predefined ‘truste’ or certification criteria established using a signature in an installation file for the application.

9. The method of claim 1 in which the device is battery powered.

10. The method of claim 1 in which the system resources that are preserved are one or more of (i) power, (ii) CPU activity and (iii) scheduler activity.

11. The method of claim 1 in which the device is powered by a UPS (uninterruptible power supply).

12. A multitasking computing device programmed to be capable of determining if an untrusted application is in the background or foreground and preventing an untrusted application that is in the background from running in order to conserve system resources.

13. Ihe device of claim 11 which is battery powered.

14. An operating system for a multitasking computing device, the operating system being capable of determining if an untrusted application is in the background or foreground and preventing an untrusted application that is in the background from running in order to conserve system resources.
